(19) United States
(12) Patent Application Publication
(10) Pub. No.: US 2025/0221428 A1
(43) Pub. Date: Jul. 10, 2025

(54) METHOD AND SYSTEM FOR CREATING A DRINK

(71) Applicant: 1014256 BC Ltd., Kelowna (CA)

(72) Inventors: Cheryle Duffin, Kelowna (CA); Michael Wiggill, Cranford (CA); Jeffrey Wiggill, Kamloops (CA)

(21) Appl. No.: 19/015,373

(22) Filed: Jan. 9, 2025

Related U.S. Application Data
(60) Provisional application No. 63/619,234, filed on Jan. 9, 2024.

(51) Int. Cl. A23G 9/04; A23G 9/08; A23G 9/40

(52) U.S. Cl. CPC A23G 9/045; A23G 9/08; A23G 9/40

(57) ABSTRACT

An apparatus and method for forming a drink within a liquid contained in a vessel. The apparatus comprises at least one body formed of a soluble material, the soluble material selected to modify at least one characteristic of the liquid, wherein each of the at least one bodies having an outer surface corresponding to a diameter of the vessel at one location therein. The method comprises locating the at least one body within the vessel so as to position the outer surface of the at least one body against the inside of the vessel and introducing a quantity of a liquid to the vessel around the at least one body.

### BACKGROUND

### 1. Technical Field

This disclosure relates generally to drinks and in particular to a method and apparatus for forming a drink within a liquid contained in a vessel.

### 2. Description of Related Art

Frozen drinks are popular in warm climates or during summer months. In particular, a frozen drink known as a Slurpee® or slushy is a common frozen drink formed by partially freezing the liquid form of the drink during agitation to form ice crystals within the suspended liquid. One popular adaption on such frozen drinks is to add a quantity of a soft serve ice cream to the top of the frozen drink to form a frozen drink/ice cream combination known as a Screamer.

One disadvantage of current frozen drink/ice cream combinations is that the ice cream placed on the top may not disperse through the entire drink leading to an inconsistent drink experience. Furthermore, many stores which include a frozen drink machine may not own or be able to also invest in a soft serve ice cream machine.

### SUMMARY OF THE DISCLOSURE

According to a first embodiment, there is disclosed an apparatus for forming a drink within a liquid contained in a vessel. The apparatus comprises at least one body formed of a soluble material, the soluble material selected to modify at least one characteristic of the liquid, wherein each of the at least one bodies having an outer surface corresponding to a diameter of the vessel at one location therein.

The at least one body may comprise at least two bodies. The at least two bodies may gave a circular outline defined by an outer radial surface. The outer radial surfaces of each of the at least two bodies may be selected to have different diameters so as to be operable to engage an interior surface of the vessel at different heights therein.

The innermost of the at least two bodies may include a bore through a center thereof. The at least two bodies comprise rings may each have an inner and outer radial surface. The outer surface of one body may be sized to have a diameter less than an inner diameter of a preceding body so as to be nestable therein. The outer surface of one body may be sized to have a diameter greater than an inner diameter of a preceding body so as to be stackable thereon.

The at least two bodies may be connected by a frangible connecting portion. The frangible connecting portion may extend in plane between nested bodies. The frangible connecting portion may extend between stacked bodies. The soluble material may be selected from the group consisting of a frozen liquid, gel or cream.

The soluble material may comprise ice cream. The apparatus may further comprise a shell over the soluble material. The shell may be formed of ice.

According to a further embodiment, there is disclosed a method of forming a drink within a liquid contained in a vessel comprising locating at least one body within the vessel so as to position the outer surface of the at least one body against the inside of the vessel and introducing a quantity of a liquid to the vessel around the at least one body.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of an apparatus for forming a drink according to a first embodiment located above a drinking vessel.

FIG. 2 is a perspective view of the apparatus of FIG. 1 according to a first configuration.

FIG. 3 is a perspective view of the apparatus of FIG. 1 located within the vessel at a second configuration.

FIG. 4 is a cross sectional view of the apparatus of FIG. 1 as taken along the line 4-4.

FIG. 5 is a cross sectional view of the apparatus of FIG. 1 according to a further embodiment.

FIG. 6 is a cross sectional view of the apparatus of FIG. 5 located within a cup.

### DETAILED DESCRIPTION

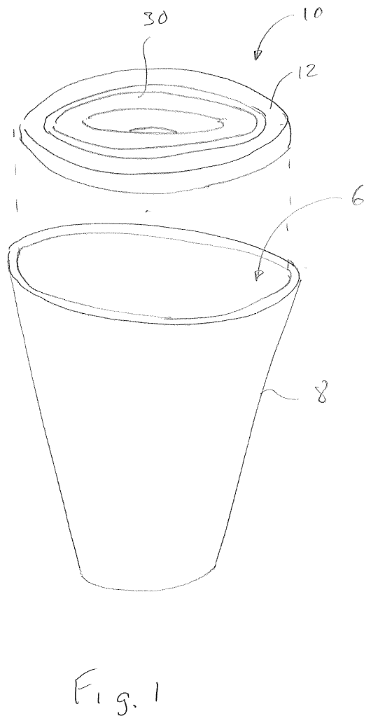

Aspects of the present disclosure are now described with reference to exemplary apparatuses, methods and systems. Referring to FIG. 1, an exemplary apparatus for forming a drink within a vessel 8 according to a first embodiment is shown generally at 10. The apparatus 10 comprises at least one body 12 formed of a dissolvable material that is capable of changing at least one characteristic of the drink liquid. In some embodiments, the apparatus may comprise concentric bodies or rings 12 and 30 operable to be located at different heights within the drink containing vessel as will be further described below.

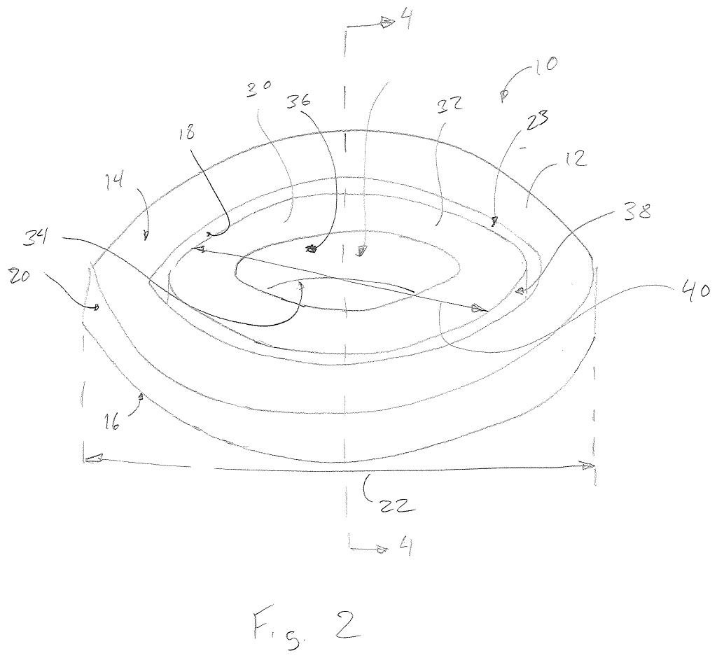

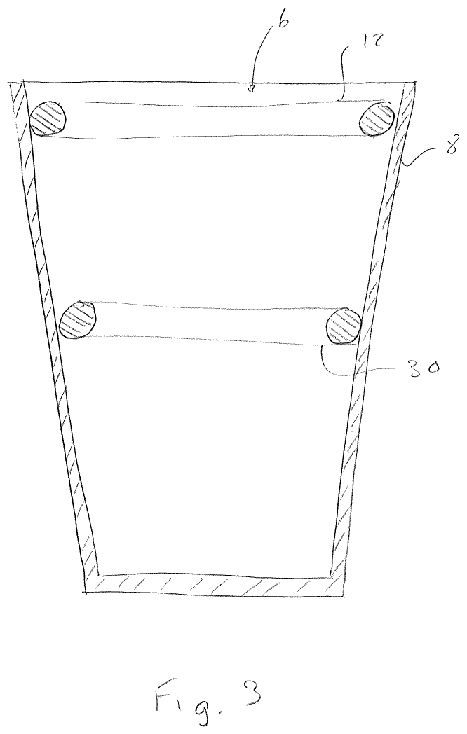

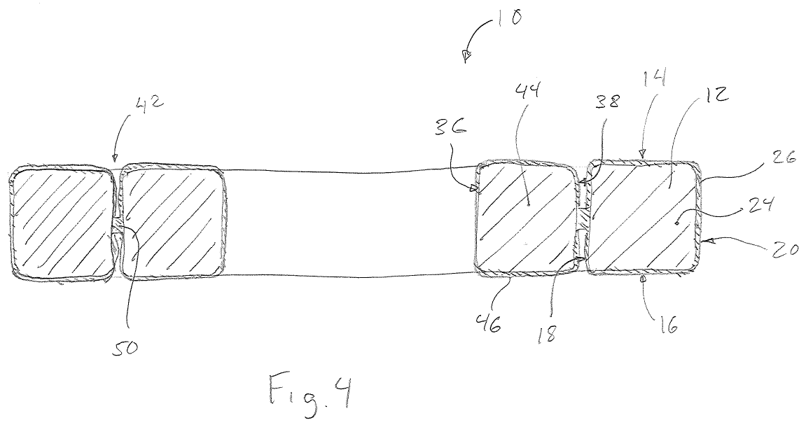

Turning now to FIG. 2, the apparatus 10 may in some embodiments be formed of first and second rings, 12 and 30, respectively. As illustrated the rings 12 and 30 may have a substantially square cross section although other shapes may also be utilized, including circular (as illustrated in FIG. 3), oval, rectangular, triangular irregular or any other desired cross sectional shape. The first ring 12 extends between top and bottom surfaces, 14 and 16, respectively and inner and outer surfaces, 18 and 20 (as illustrated in FIG. 4), respectively. The outer surface 20 defines an outer diameter 22 sized to correspond to one location within an interior cavity 6 of the vessel.

The second ring 30 may be formed between top and bottom surfaces, 32 and 34, respectively and inner and outer surfaces, 36 and 38, respectively. The outer surface 38 defines an outer diameter 40 sized to correspond to a second location within the interior cavity 6 of the vessel 8. As illustrated in FIG. 3, the second location may be lower within the vessel than the first location so as to vertically offset the top first and second rings 12 and 30 therein. The outer diameter 40 is selected to fit within an opening 23 formed by the inner surface 18 of the first ring 12. The inner surface 36 of the second body 30 forms a passage 37 therein which may receive subsequent bodies or may be left open to permit the introduction and passage of drink contents or a straw therethrough. As illustrated in FIG. 4, the inner and outer rings 12 and 30 may be connected by a frangible portion 50. The frangible portion 50 is strong enough to keep the first and second rings 12 and 30 together during transportation and storage but may be broken when placed within a vessel 8 so as to permit the first and second rings 12 and 30 to fall to different depths in the vessel as illustrated in FIG. 3.

As illustrated in FIGS. 2 and 4 a gap, generally indicated at 42 may be formed between the inner surface 18 of the first ring 12 and the outer surface 38 of the second ring. The gap 42 may be selected to permit movement and securing of the second ring 30 within the first ring 12 such as, by way of non-limiting embodiments, up to ¼ inches (6 mm). As illustrated in FIGS. 2 and 4, the cross sectional shapes of the first and second rings 12 and 30 may be selected to be substantially the same, although it will be appreciated that they may also be selected to be different from each other as desired by a user.

Turning now to FIG. 4, the first and second rings 12 and 30 may be formed with an inner portion 24 and 44, respectively and an outer shell, 26 and 46, respectively. The inner portion may be formed of a material intended to alter or add to the beverage to be formed in the vessel 8. Non-limiting examples of such materials include ice cream, gels or frozen liquids. In some embodiments, the inner portion may be formed of a liquid soluble material so as to be dispersible within the liquid introduced into the vessel 8. Optionally, the inner portion material may be selected to provide one or more additive properties to the beverage including, without limitation, sweeteners, food colouring or flavour enhancements. The shell 26 and 46 may be formed of a solid material selected to protect and seal the inner portion from exposure to atmosphere. By way of non-limiting example, the shell 26 and 44 may be formed of a frozen liquid, including ice or glazes including solidified sugar. In operation, it is intended that the shell 26 and 46 will melt or dissolve when placed in a liquid permitting the inner portion 24 and 44 to come into contact with the beverage. Optionally, the shell 26 and 46 may be omitted.

In operation, a user may place the apparatus 10 within a vessel 8 as illustrated in FIG. 3. As shown the frangible portion 50 may be broken permitting the second ring 30 to fall to a lower depth than the first ring 12. Thereafter a beverage, including without limitation, a slushy may be introduced into the vessel 8 around an through the first and second rings 12 and 30. It will be appreciated that in embodiments where the first and body and in particular the inner portions 24 and 44 thereof are formed of ice cream, that the resulting beverage will be a combination of slush and ice cream, which is commonly known as a screamer. Advantageously, this will permit establishments that do not have access to a soft serve ice cream machine to sell such drinks. It will also be appreciated that in such a new drink, the ice cream will be more distributed throughout the drink than is commonly formed.

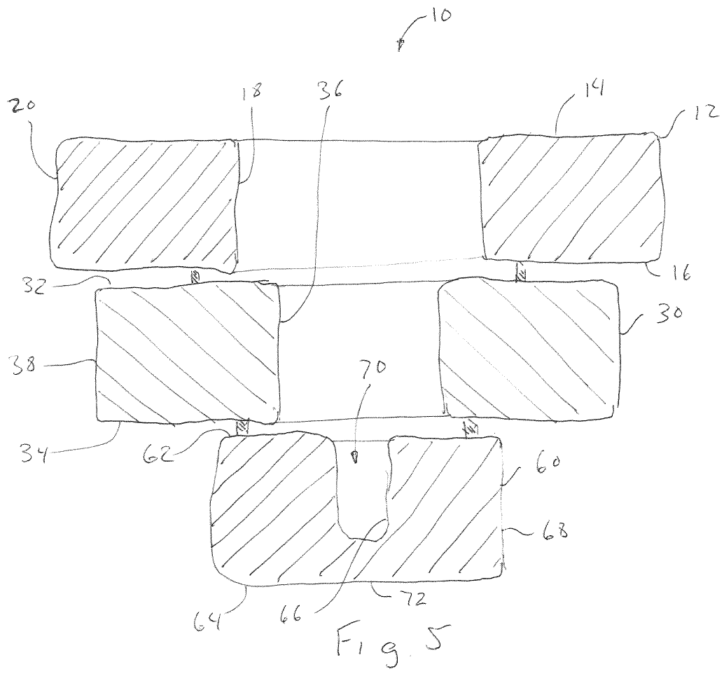

Optionally, the more than two rings, such as by way of non-limiting embodiment, three rings may be utilized as illustrated in FIG. 5. Furthermore, although the rings are illustrated as concentrically arranged with each other in FIG. 1-5, it will also be appreciate that the inner bores may be sized to not receive a subsequent ring therein such that the rings 12, 30 and 60 are stacked on each other as illustrated in FIG. 5. In particular, in such an arrangement, the inner surface 18 of the first ring 12 is smaller than the outer surface 38 of the second ring 30 and the inner surface 36 of the second ring 30 is smaller than an outer surface 68 of the third ring 60. Furthermore, as optionally illustrated in FIG. 5, the portion of an inner bore 70 formed by the inner surface 66 of the third ring may be closed along the bottom surface 64 at a sealed end 72.

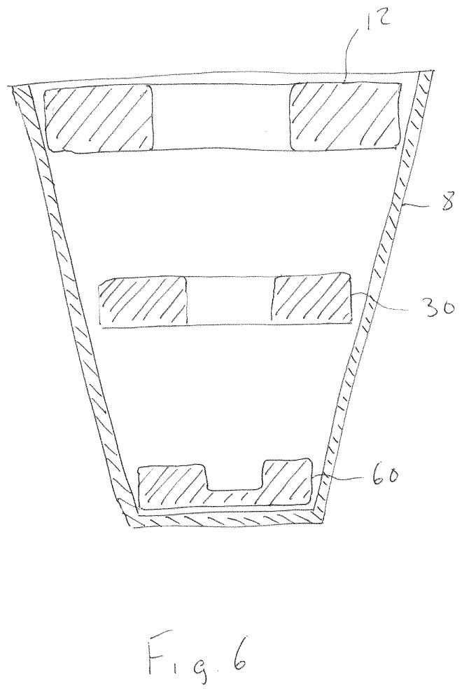

As Illustrated in FIG. 6, the first second and third rings 12, 30 and 60 may be located within the cup 8 at a top middle and bottom portion therealong after the frangible portion 50 is severed. The sealed end 72 may facilitate such separation of the frangible portions 50 by providing a surface on which to push with a straw or the like.

While specific embodiments have been described and illustrated, such embodiments should be considered illustrative only and not as limiting the disclosure as construed in accordance with the accompanying claims.

What is claimed is:

1. An apparatus for forming a drink within a liquid contained in a vessel, the apparatus comprising:
at least one body formed of a soluble material, the soluble material selected to modify at least one characteristic of the liquid,
wherein each of the at least one bodies having an outer surface corresponding to a diameter of the vessel at one location therein.

2. The apparatus of claim 1 wherein the at least one body comprises at least two bodies.

3. The apparatus of claim 2 wherein the at least two bodies have a circular outline defined by an outer radial surface.

4. The apparatus of claim 3 wherein the outer radial surfaces of each of the at least two bodies are selected to have different diameters so as to be operable to engage an interior surface of the vessel at different heights therein.

5. The apparatus of claim 2 wherein the innermost of the at least two bodies includes a bore through a center thereof.

6. The apparatus of claim 2 wherein the at least two bodies comprise rings each having an inner and outer radial surface.

7. The apparatus of claim 6 wherein the outer surface of one body is sized to have a diameter less than an inner diameter of a preceding body so as to be nestable therein.

8. The apparatus of claim 6 wherein the outer surface of one body is sized to have a diameter greater than an inner diameter of a preceding body so as to be stackable thereon.

9. The apparatus of claim 2 wherein the at least two bodies are connected by a frangible connecting portion.

10. The apparatus of claim 9 wherein the frangible connecting portion extends in plane between nested bodies.

11. The apparatus of claim 9 wherein the frangible connecting portion extends between stacked bodies.

12. The apparatus of claim 1 wherein the soluble material is selected from the group consisting of a frozen liquid, gel or cream.

13. The apparatus of claim 12 wherein the soluble material comprises ice cream.

14. The apparatus of claim 12 further comprising a shell over the soluble material.

15. The apparatus of claim 14 wherein the shell is formed of ice.

16. A method for forming a drink within a liquid contained in a vessel, the method comprising:
locating at least one concentric body within the vessel so as to position the outer surface of the at least one concentric body against the inside of the vessel; and
introducing a quantity of a liquid to the vessel around the at least one concentric body.
